(19) United States
(12) Patent Application Publication
(10) Pub. No.: US 2017/0118548 A1
(43) Pub. Date: Apr. 27, 2017

(54) EARTIP AND EARPHONE DEVICE USING THE SAME

(71) Applicant: Acer Incorporated, New Taipei City (TW)

(72) Inventors: Feng-Ming LIU, New Taipei City (TW); Jia-Ren CHANG, New Taipei City (TW)

(21) Appl. No.: 15/240,300

(22) Filed: Aug. 18, 2016

(30) Foreign Application Priority Data
Oct. 21, 2015 (TW) 104134499

(51) Int. Cl. H04R 1/10; H04R 1/28

(52) U.S. Cl. CPC H04R 1/1016; H04R 1/2803; H04R 2460/11

(57) ABSTRACT

An earphone device is provided. The earphone device includes a main body and an eartip connected to the main body. The main body includes a chamber and a speaker. The speaker is disposed in the chamber. The eartip includes a communicating tube extending along an axis. A sound inlet and a sound outlet are formed on two ends of the communicating tube that are located at the axis, and a pressure-releasing hole penetrates a side wall of the communicating tube for pressure adjustment.

### CROSS REFERENCE TO RELATED APPLICATIONS

This Application claims priority of Taiwan Patent Application No. 104134499, filed on Oct. 21, 2015, the entirety of which is incorporated by reference herein.

### BACKGROUND

Field of the Invention

The present invention relates to an earphone device and elements thereof, and more particularly to an earphone device and an eartip thereof.

Description of the Related Art

An earphone (also known as a headphone or earspeaker) is a pair of transducing units that receive electrical signals from a media player or an electronic device and convert these signals to corresponding acoustic waves that can be heard by a human being via a speaker, which is adapted to be attached around the user's ear. Generally, the earphone is detachable from the media player and is connected to the media player via a connector. The earphone is designed to allow a single user to listen to an audio source privately without disturbing other people.

According to the operating principles of the transducer in the earphone, the earphones can be classified into dynamic earphones, electrostatic earphones, piezoelectric earphones, moving iron earphones, pneumatic earphones, electromagnetic earphones, etc. The transducers convert electrical signals into sound by using different transducing technologies so as to meet the various sound quality requirements of the user.

In addition, the various earphone can be divided into four separate categories: circumaural (over-ear), supra-aural (on-ear), ear bud, and canalphones (in-ear), in which the canalphones can provide a high-quality listening experience with a noise-isolation function.

### SUMMARY

One objective of the present invention is to provide an eartip which is adapted for use in an earphone device. With the use of the eartip, the user can feel comfortable wearing the earphone device, and eardrum injuries (which can happen when an earphone device is worn on or removed from the user's ear) can be prevented.

In accordance with some embodiments of the disclosure, the eartip includes a communicating tube, extending along an axis, wherein a sound inlet and a sound outlet are formed on two ends of the communicating tube that arranged on the axis, and a pressure-releasing hole penetrates a side wall of the communicating tube.

In the above-mentioned embodiments, the eartip further includes an extension portion, a fixing end of the extension portion is connected to an edge of the sound outlet, and the extension portion extends toward the sound outlet and terminates at a free end, wherein in a direction that is perpendicular to the axis, the pressure-releasing hole is closer to the axis than the extension portion.

In the above-mentioned embodiments, the number of pressure-releasing holes is more than one, and the pressure-releasing holes are circumferentially arranged at the communicating tube to be paced apart from each other by a fixed distance.

In the above-mentioned embodiments, the diameter of the pressure-releasing hole is in a range of 0.5 mm to 1 mm.

In the above-mentioned embodiments, the eartip is made of silicon rubber, low-pressure form material, or elastic polyester material.

Another objective of the disclosure is to provide an earphone device. The earphone device includes an eartip and a main body. The main body includes a chamber comprising a front sound channel for transmitting sound and a speaker disposed in the chamber. The eartip includes a communicating tube. A sound inlet and a sound outlet are formed on two ends of the communicating tube. The eartip is connected to the front sound channel via the sound inlet, and a pressure-releasing hole penetrates a side wall of the communicating tube.

In the above-mentioned embodiments, the eartip further includes an extension portion. A fixing end of the extension portion is connected to an edge of the sound outlet, and the extension portion extends toward the main body and terminates at a free end. The communicating tube extends along an axis, and, in a direction that is perpendicular to the axis, the pressure-releasing hole is closer to the axis than the extension portion.

In the above-mentioned embodiments, the pressure-releasing holes are closer to the axis than the front sound channel.

In the above-mentioned embodiments, the earphone device further includes a sound-enhancing hole formed on a wall of the front sound channel.

In the above-mentioned embodiments, there is more than one pressure-releasing hole, and the pressure-releasing holes are circumferentially arranged on the communicating tube and spaced apart from each other by a fixed distance.

### BRIEF DESCRIPTION OF THE DRAWINGS

For a more complete understanding of the embodiments and the advantages thereof, reference is now made to the following descriptions taken in conjunction with the accompanying drawings.

FIG. 1 shows an exploded view of an earphone device, in accordance with a first embodiment of the disclosure.

FIG. 2 shows a cross-sectional view of the earphone device, in accordance with the first embodiment of the disclosure.

FIG. 3 shows a schematic view illustrating the operating state of the earphone device as the eartip is inserted into the user's ear, in accordance with the first embodiment of the disclosure.

FIG. 4 shows a schematic view illustrating the operating state of the earphone device as the eartip is removed from the user's ear, in accordance with the first embodiment of the disclosure.

FIG. 5 shows a schematic view of an earphone device, in accordance with a second embodiment of the disclosure.

FIG. 6 shows a schematic view of an earphone device, in accordance with a third embodiment of the disclosure.

### DESCRIPTION OF THE ILLUSTRATIVE EMBODIMENTS

In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments.

It should be noted that the elements or devices in the drawings of the present disclosure may be present in any form or configuration known to those skilled in the art. In addition, the expression “a layer overlying another layer”, “a layer is disposed above another layer”, “a layer is disposed on another layer” and “ a layer is disposed over another layer” may indicate not only that the layer directly contacts the other layer, but also that the layer does not directly contact the other layer, there being one or more intermediate layers disposed between the layer and the other layer.

In this specification, relative expressions are used. For example, “lower”, “bottom”, “higher” or “top” are used to describe the position of one element relative to another. It should be appreciated that if a device is flipped upside down, an element at a “lower” side will become an element at a “higher” side.

The terms “about” and “substantially” typically mean +/−20% of the stated value, more typically +/−10% of the stated value and even more typically +/−5% of the stated value. The stated value of the present disclosure is an approximate value. When there is no specific description, the stated value includes the meaning of “about” or “substantially”.

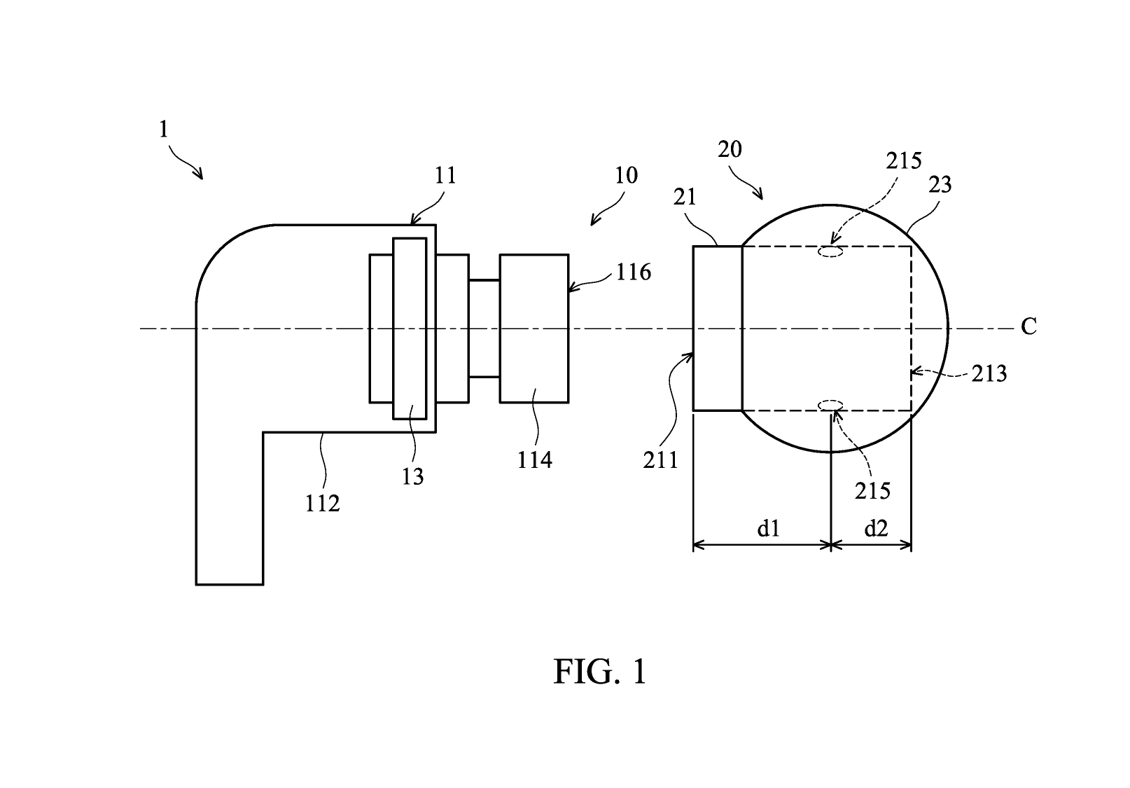

FIG. 1 shows an exploded view of an earphone device 1, in accordance with a first embodiment of the disclosure. In some embodiments, the earphone device 1 includes a main body 10 and an eartip 20.

In some embodiments, the main body 10 includes a chamber 12 and a speaker 13. The chamber 11 includes a rear enclosure 112 and a front sound channel 114. The front sound channel 114 is connected to the rear enclosure 112 and extends along an axis C. The speaker 13 is disposed in the intersection of the rear enclosure 112 and the front sound channel 114. The speaker 13 is configured to receive electric signals from a media player or an electronic device (such as mobile phone, tablet, or notebook) and convert these signals into acoustic waves. Resonance of the acoustic wave produced by the speaker 13 occurs in the rear enclosure 112 and the front sound channel 114 and is transmitted toward the eartip 20 via a sound outlet 116 of the front sound channel 114.

In some embodiments, the eartip 20 includes a communicating tube 21 and an extending portion 23. The communicating tube 21 is a tube extending along the axis C. In some embodiments, the communicating tube 21 has a unity diameter and has a sound inlet 211 and a sound outlet 213 respectively formed at two ends of the communicating tube 21 that is arranged on the axis C.

Moreover, two pressure-releasing holes 215 are formed at the side wall of the communicating tube 21, wherein the two pressure-releasing holes 215 are spaced from one the other by a distance in the circumferential direction of the communicating tube 21 and not connected to the other. The two pressure-releasing holes 215 may have the same or different diameter. In some embodiments, the diameter of the two pressure-releasing holes 215 is in a range from 0.5 mm to 1 mm.

The two pressure-releasing holes 215 may space from the sound inlet 211 or the sound outlet 213 by the same distance or different distances. For example, the two pressure-releasing holes 215 are spaced from the sound inlet 211 by a distance of d1, and the two pressure-releasing holes 215 are spaced from the sound outlet 213 by a distance of d2. In some embodiments, the two pressure-releasing holes 215 is arranged to be closer to the sound outlet 213 than the sound inlet 211, so that that the distance d2 is less than the distance d1. With such configuration, after the communicating tube 21 is connected to the front sound channel 114, the two pressure-releasing holes 215 are not overlapped with the outer wall of the front sound channel 114.

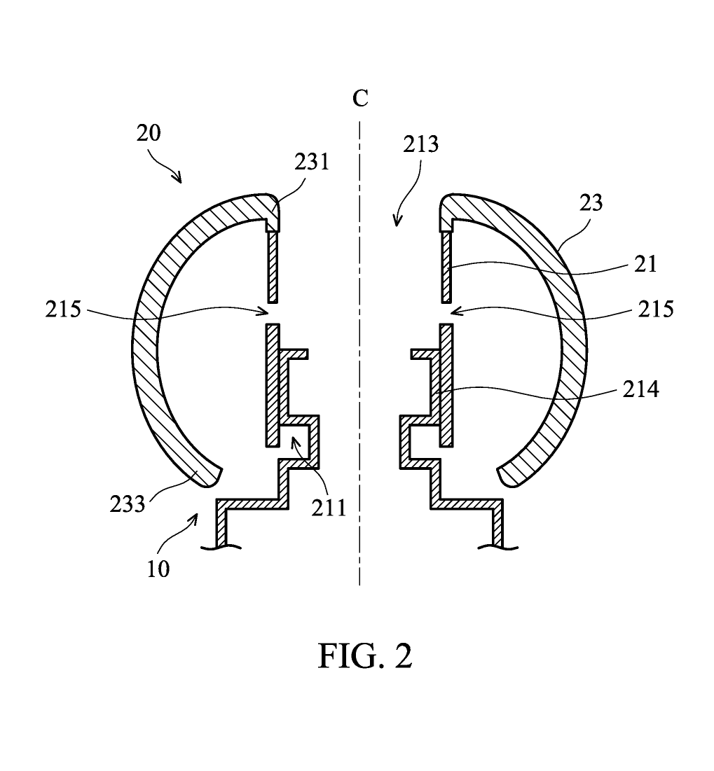

Referring to FIG. 2, in the use of the eartip 20, the extending portion 23 thereof is in contact with the inner wall of the user's ear canal. In some embodiments, a fixing end 231 of the extension portion 23 is connected to an edge of the sound outlet 213 of the communicating tube 21. The extension portion 23 extends rearward (toward the main body 10) from the fixing end 231 and terminates at a free end 233. The extension portion 23 may have a curved surface to facilitate the wearing.

It should be noted that, as shown in FIG. 2, in some embodiments, in a direction perpendicular to the axis C, the two pressure-releasing holes 215 are located at a side of the extension portion 23 that is closer to the axis C. That is, in the direction perpendicular to the axis C, the projection of the two pressure-releasing holes 215 are located on the extension portion 23.

The communicating tube 21 and the extension portion 23 of the eartip 20 may be made by the same or the different materials. In some embodiments, the eartip 20 is made of materials which selected from at least one of silicon rubber, low-pressure form material, or elastic polyester material. In some embodiments, the communicating tube 21 and the extension portion 23 of the eartip 20 are fabricated by double shot mold injection process.

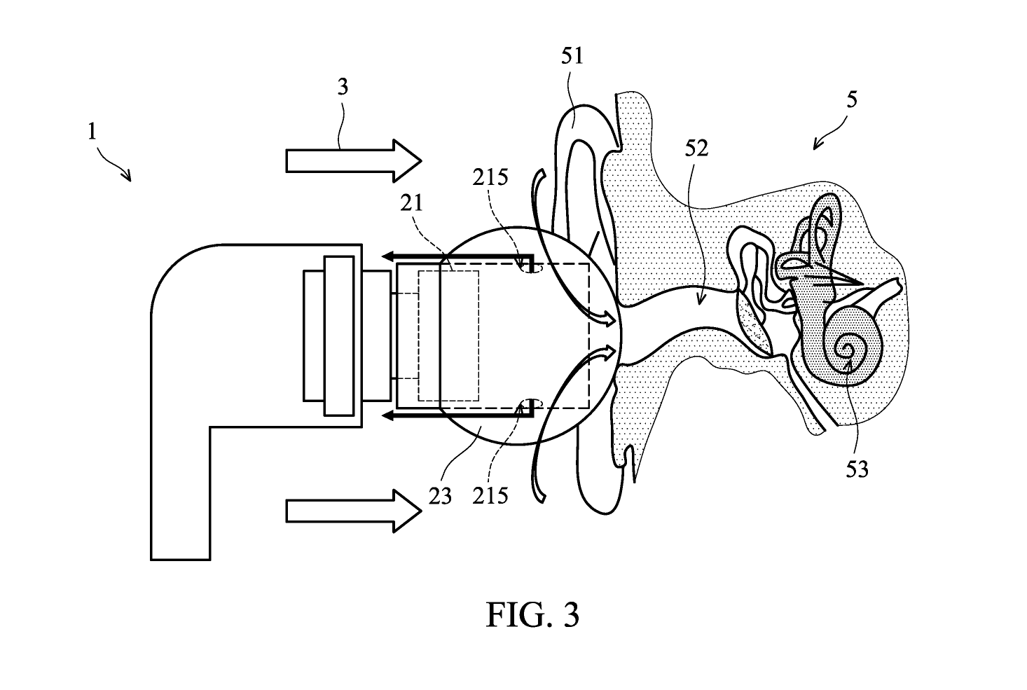

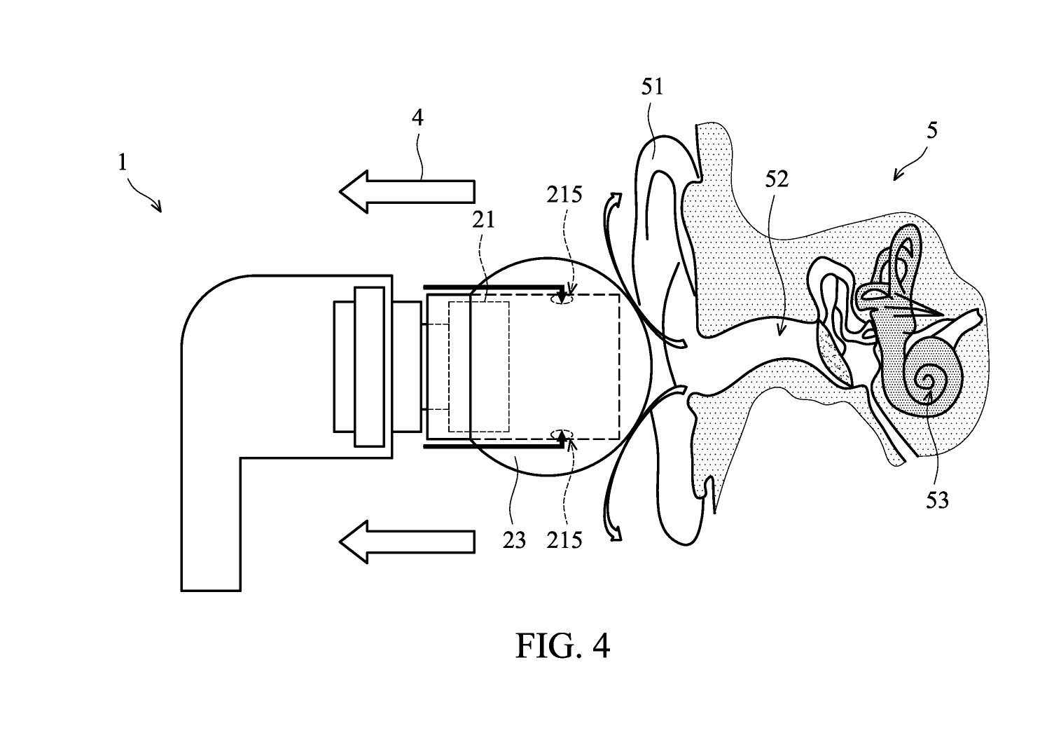

Referring to FIGS. 3 and 4, the method for using the earphone device 1 is described below.

To wear the earphone device 1 on the ear 5, the user moves the eartip 20 toward the pinna 51 along the wearing direction indicated by arrow 3 in FIG. 3, and inserts a portion of the extension portion 23 into the ear canal 52. During this process, the air in the ear canal 52 is exhausted via the slit between the extension portion 23 and the inner wall of the ear canal 52 or via the pressure-releasing holes 215 of the eartip 20. Therefore, the uncomfortable feeling of the eardrum 53 being squeezed by air pressure can be avoided.

To remove the earphone device 1 from the ear 5, the user moves the eartip 20 away from the pinna 51 along the wearing direction indicated by arrow 4 in FIG. 4, and pulls the portion of the extension portion 23 out of the ear canal 52. During this process, the air in the outside surroundings flows into the ear canal 52 via the slit between the extension portion 23 and the inner wall of the ear canal 52 or via the pressure-releasing holes 215 of the eartip 20. Therefore, the uncomfortable feeling as the eardrum 53 is being stretched by air pressure can be avoided.

It should be noted that, while there are two pressure-releasing holes 215 that are formed on the side wall of the communicating tube 21 in the embodiment shown in FIG. 1, the number of pressure-releasing holes 215 should not be limited to the embodiment. In some embodiments, there is only one pressure-releasing hole 215 formed on the side wall of the communicating tube 21.

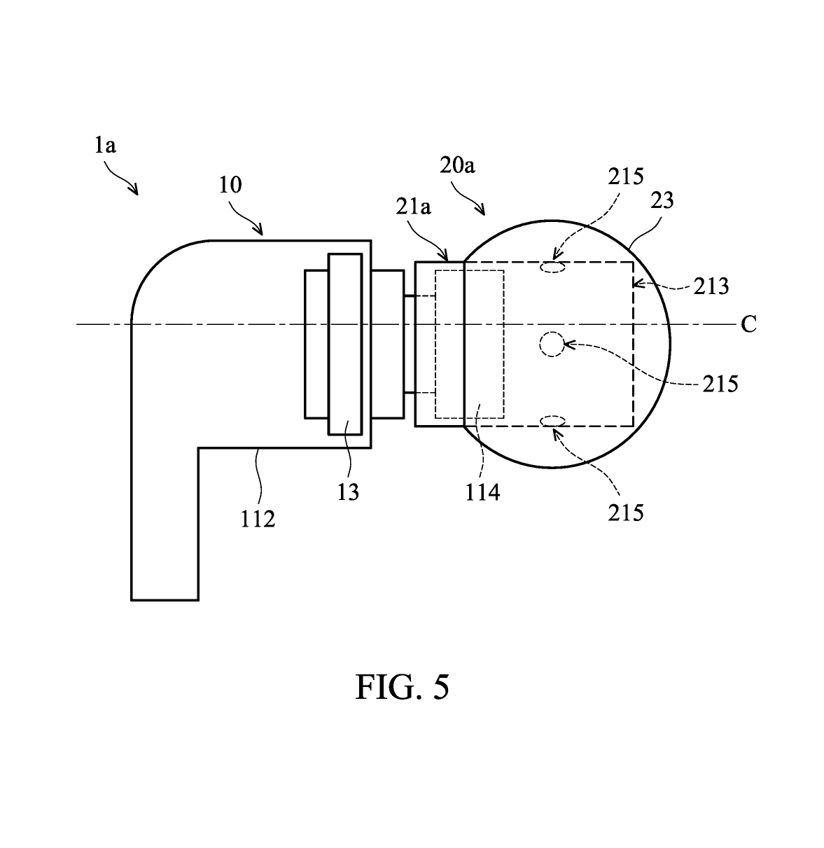

In some embodiments, as shown in FIG. 5, the earphone device 1a includes a main body 10 and an eartip 20a. Three pressure-releasing holes 215 are formed on the side wall of the communicating tube 21a. The three pressure-releasing holes 215 may be circumferentially arranged at the communicating tube 21a and spaced apart from each other by a fixed or variable distance. Additionally or alternatively, the three pressure-releasing holes 215 may be arranged to be spaced apart from the main body 10 by a fixed or varied distance. Additionally or alternatively, the three pressure-releasing holes 215 may have the same diameter or different diameters.

In some embodiments, four pressure-releasing holes 215 are formed on the side wall of the communicating tube 21a. The four pressure-releasing holes 215 may be circumferentially arranged at the communicating tube 21a and spaced apart from each other by a fixed or varied distance. For example, two of the pressure-releasing holes 215 are arranged symmetrically in a horizontal direction, and the other two of the pressure-releasing holes 215 are arranged symmetrically in a vertical direction. Additionally or alternatively, the four pressure-releasing holes 215 may be arranged to be spaced apart from the main body 10 by a fixed or varied distance. Additionally or alternatively, the four pressure-releasing holes 215 may have the same diameter or different diameters.

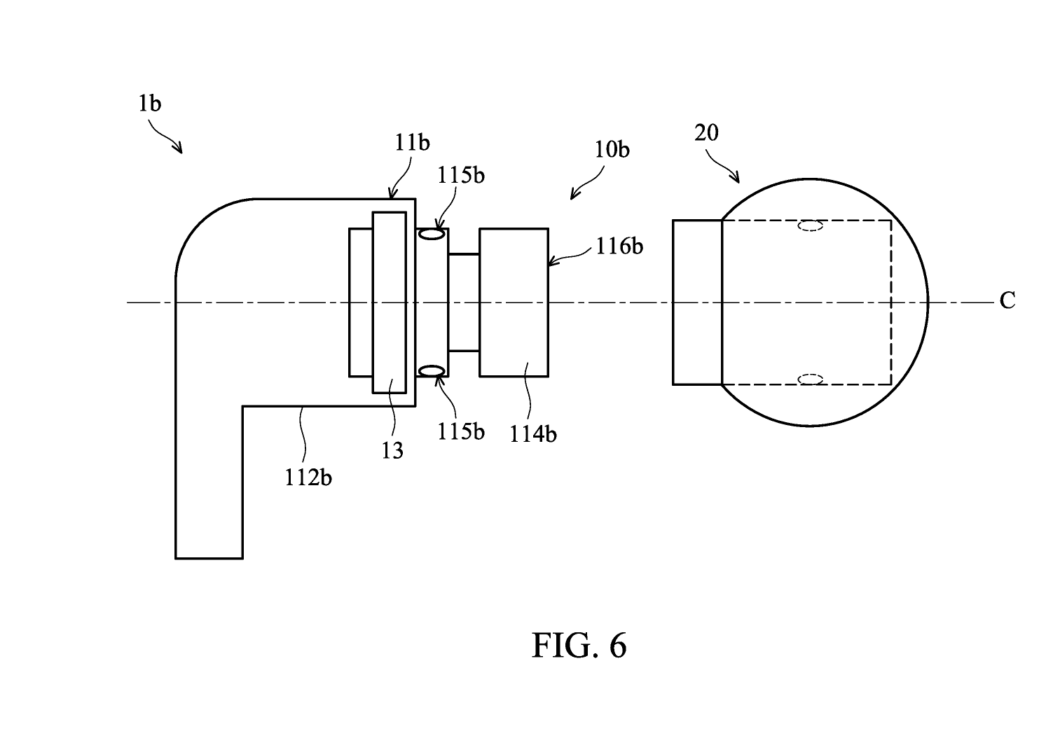

FIG. 6 shows a schematic view of an earphone device 1b, in accordance with a first embodiment of the disclosure. In the embodiment shown in FIG. 6, elements that are identical with or similar to the elements of the earphone device 1 shown in FIG. 1 are designated by the same reference number, and the features thereof are not repeated for the purpose of brevity. The differences between the earphone device 1 and the earphone device 1b include the main body 10 of the earphone device 1 being replaced by a main body 10b.

The main body 10b includes a chamber 11b and a speaker 13. The chamber 11b includes a rear enclosure 112b and a front sound channel 114b. The front sound channel 114b is connected to the rear enclosure 112b and extends along an axis C. The speaker 13 is disposed in the intersection of the rear enclosure 112b and the front sound channel 114b. Resonance of the acoustic wave produced by the speaker 13 occurs in the rear enclosure 112b and the front sound channel 114 and is transmitted toward the eartip 20 via a sound outlet 116b of the front sound channel 114. Two sound-enhancing holes 115 are formed on the wall of the front sound channel 114b. The two sound-enhancing holes 115 are spaced from the sound outlet 116b by a distance. With this configuration, after the eartip 20 is connected to the front sound channel 114b, the two sound-enhancing holes 115 are not covered by the eartip 20.

Due to the arrangements of the two sound-enhancing holes 115, the sound quality of the earphone device 1b is improved. In addition, since the sound-enhancing holes 115 are connected to the communicating tube 21 of the eartip 20 via the sound outlet 116b, the air pressure in the ear canal can be balanced with the outside surroundings via the sound-enhancing holes 115 during the wearing or removal of the earphone 1b, and eardrum injuries can therefore be avoided.

Embodiments of the earphone device have at least one gas hole for balancing the air pressure in the user's ear canal and the outside surroundings. Therefore, during the wearing or removal of the earphone device, the force field that may cause eardrum injuries will not be produced in the user's ear canal, and the eardrum injuries such as deformation of the ear drum or damage to the ear drum are avoided.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A eartip, comprising:
a communicating tube extending along an axis, wherein a sound inlet and a sound outlet are formed on two ends of the communicating tube that are arranged on the axis, and a pressure-releasing hole penetrates a side wall of the communicating tube.

2. The eartip as claimed in claim 1, further comprising an extension portion, a fixing end of the extension portion is connected to an edge of the sound outlet, and the extension portion extends toward the sound outlet and terminates at a free end, wherein in a direction that is perpendicular to the axis, the pressure-releasing hole is closer to the axis than the extension portion.

3. The eartip as claimed in claim 1, wherein the number of pressure-releasing holes is more than one, and the pressure-releasing holes are circumferentially arranged at the communicating tube and spaced apart from each other by a fixed distance.

4. The eartip as claimed in claim 1, wherein the diameter of the pressure-releasing hole is in a range of 0.5 mm to 1 mm.

5. The eartip as claimed in claim 1, wherein the eartip is made of silicon rubber, low-pressure form material, or elastic polyester material.

6. An earphone device, comprising:
a main body comprising:
a chamber comprising a front sound channel for transmitting sound; and
a speaker disposed in the chamber; and
an eartip, comprising a communicating tube, and a sound inlet and a sound outlet formed on two ends of the communicating tube, wherein the eartip is connected to the front sound channel via the sound inlet, and a pressure-releasing hole penetrates a side wall of the communicating tube.

7. The earphone device as claimed in claim 6, wherein the eartip further comprises an extension portion, a fixing end of the extension portion is connected to an edge of the sound outlet, and the extension portion extends toward the main body and terminates at a free end;
wherein the communicating tube extends along an axis, and the pressure-releasing hole is closer to the axis than the extension portion in a direction that is perpendicular to the axis.

8. The earphone device as claimed in claim 6, wherein the pressure-releasing hole is closer to the axis than the front sound channel.

9. The earphone device as claimed in claim 6, further comprising a sound-enhancing hole formed on a wall of the front sound channel.

10. The earphone device as claimed in claim 6, wherein the number of pressure-releasing holes is more than one, and the pressure-releasing holes are circumferentially arranged at the communicating tube and spaced apart from each other by a fixed distance.
